(19) United States
(12) Patent Application Publication
(10) Pub. No.: US 2025/0206606 A1
(43) Pub. Date: Jun. 26, 2025

(54) PROCESS FOR PRODUCING HYDROGEN FROM HYDROGEN-CONTAINING GAS

(71) Applicant: UOP LLC, Des Plaines, IL (US)

(72) Inventors: Lubo ZHOU, Des Plaines, IL (US); Zhengjie YAO, Des Plaines, IL (US); Stephen CASKEY, Des Plaines, IL (US); Bradley RUSSELL, Des Plaines, IL (US)

(21) Appl. No.: 18/846,848

(22) PCT Filed: Mar. 15, 2022
(86) PCT No.: PCT/CN2022/080903

§ 371 Date: Sep. 13, 2024

(51) Int. Cl. C01B 3/50; B01D 53/22; C01B 3/34

(52) U.S. Cl. CPC C01B 3/501; B01D 53/229; C01B 3/34; B01D 2256/16; C01B 2203/0233; C01B 2203/0244; C01B 2203/025; C01B 2203/0283; C01B 2203/043; C01B 2203/046; C01B 2203/0475; C01B 2203/048; C01B 2203/0485; C01B 2203/147

(57) ABSTRACT

Processes for producing hydrogen from hydrogen-containing gas streams, such as coke oven gas (COG), steam cracker off gas, delayed coker off gas, and syngas from low-temperature gasification processes, are described. A hydrogen membrane separation unit separates a hydrogen-containing stream into a hydrogen-rich permeate stream and a hydrogen-lean residue stream. The hydrogen-lean residue stream is sent to a methane reforming zone for conversion of the methane and other light hydrocarbons to hydrogen. The hydrogen is then recovered in a hydrogen recovery zone. The hydrogen-containing stream can be pretreated to remove contaminants, if desired.

### BACKGROUND

Today, hydrogen is supplied almost entirely from fossil fuels, with more than 70% generated from natural gas and around 27% generated from coal. Electricity as an energy input for electrolysis accounts for less than 1% of the H₂ production, with fossil fuels still indirectly accounting for the majority of this, due to the electricity for electrolysis being largely produced from fossil fuels in the countries where the hydrogen is produced.

In energy terms, the total annual hydrogen production worldwide is 70-73 million metric tons of hydrogen per year (MMTA). The hydrogen is produced in dedicated facilities, primarily located near the point of use. Its main uses are upgrading petroleum products in refinery applications (38 MMTA), and as a feedstock for ammonia production (31 MMTA).

In addition to this dedicated hydrogen demand, another 45-48 MMTA is produced as a byproduct from other processes. The main uses of this hydrogen byproduct production are in the manufacture of methanol (12 MMTA), in the manufacture of steel (4 MMTA), and in other applications such as synthesis gas for fuel or feedstock and process heating (26 MMTA).

By 2050, the total hydrogen demand could reach 650 MMTA, approximately five times current production levels. Hydrogen would be used primarily for industrial feedstock and energy, together with transportation, heating and power in buildings, and power generation usage, including hydrogen buffering.

Steel accounts for 15% of China's carbon emissions, the largest segment among manufacturers. Consequently, it is an important sector to address as the country plots its course to a carbon-neutral economy by 2060. Energy-saving technologies can reduce CO₂ emissions in the short term. However, in the long term, climate change mitigation will likely require adopting breakthrough technologies, such as carbon capture and storage (CCS) and hydrogen-based direct reduction (DR), increasing the share of scrap-based electric arc furnace (EAF) steel production, and decarbonizing upstream energy-supply sectors. Hydrogen-based DR could be an effective option for CO₂ emission reduction in scenarios where CCS is not available, with its share increasing to 23%-25% by 2050. As a result, there will be a huge demand for affordable hydrogen in the steel industry.

Although the production cost of hydrogen from coal could be as low as 11 CNY/kg in China, the estimated CO₂ emissions per kilogram of hydrogen produced, or “carbon intensity,” of hydrogen from unabated coal gasification is 19 kg CO₂/kg H₂. This is about twice the value of the carbon intensity from steam methane reforming (SMR) of natural gas. The production cost of hydrogen by methane could be 21.6 CNY/kg, and with increasing methane demand, the H₂ production cost could be even higher. The production cost of hydrogen by water electrolysis could be as high as 36.2 CNY/kg.

Currently, the high carbon intensity (i.e., coal to H₂) or high production cost (i.e., methane to H₂ and water electrolysis) of present hydrogen production technology poses an obstacle for the steel industry to reduce carbon emission by hydrogen-based direct reduction.

Coke oven gas (COG) is a by-product of coal carbonization process, and it mainly comprises H₂ (55-60 vol %), CO (5-8 vol %), CO₂ (3-6 vol %), CH₄ (23-27 vol %), and other impurities (e.g., N₂ and H₂S). On average, 1.25-1.65 tons coal can produce 300-360 m³ of COG. China, which is the largest country for coke production in the world, produces approximately 210 billion m³ of COG at present.

Considering the hydrogen content in COG and the huge amount involved, several processes have been developed to separate hydrogen from the COG.

CN 103275777 describes a process in which pretreated COG is compressed and subjected to a water-gas shift (WGS) reaction and desulfurized. CO₂ is removed in a CO₂ pressure swing adsorption (PSA) unit. The COG is compressed and sent to an H₂ PSA where the hydrogen is recovered. The tail gas is compressed, desulfurized, and the CO and H₂ in the stream are converted into methane. Liquefied natural gas (LNG) is separated out by cryogenic separation, and the remainder is recycled to the COG pretreatment section.

In CN 106315510, the pretreated COG is hydrotreated and compressed before being sent to a hydrocarbon conversion process. The reaction product is sent to a WGS reactor. CO₂ is removed by vacuum adsorption. The stream is sent to an H₂ PSA to recover hydrogen, and the tail gas is recycled to the COG pretreatment section.

CN 107512702 discloses a process in which the COG is compressed, pretreated, and compressed a second time. The COG is treated in a de-oil mist column and sent to an H₂ PSA unit. The stream is subjected to catalytic deoxygenation to remove oxygen. The moisture is removed in a temperature swing (TSA) unit to get high purity hydrogen, with the desorbed gas being sent to the COG pretreatment section.

The process of CN 113430024 involves compressing pretreated COG and removing naphthalene. The COG is reacted in a WGS reactor, followed by sulfur removal. The de-sulfurized gas is sent to a CO₂ PSA, followed by a CH₄ PSA, and an H₂ PSA. The H₂ PSA tail gas is recycled to the CO₂ PSA and the CH₄ PSA as purge gas. The CO₂ PSA tail gas is sent to a coker as fuel gas, and the CH₄ PSA tail gas is compressed and sent to a methane municipal network.

Although these processes extract hydrogen from hydrogen-containing gas, none solves the problem of making the maximum amount of hydrogen from hydrogen-containing gas at an affordable cost.

Therefore, considering the carbon net zero initiatives and increasing demand for hydrogen, there is a need for processes for producing the maximum amount hydrogen from hydrogen-containing gases, including but not limited to, COG, steam cracker off gas, delayed coker off gas, and syngas from low temperature gasification processes.

### BRIEF DESCRIPTION OF THE DRAWING

FIG. 1 is an illustration of one embodiment of the process of the present invention.

### DETAILED DESCRIPTION

Novel processes for producing hydrogen from hydrogen-containing gas streams have been developed. A hydrogen membrane separation unit separates hydrogen-containing gas stream into a hydrogen-rich permeate stream comprising 70 mol % to 95 mol % hydrogen and 5 mol % to 20 mol % methane and a hydrogen-lean residue stream comprising 20 mol % to 90 mol % methane, 10 mol % to 40 mol % hydrogen and 2 mol % to 20 mol % carbon monoxide. The hydrogen-lean residue stream is sent to a methane reforming zone for conversion of the methane and other light hydrocarbons to hydrogen. The hydrogen is then recovered in a hydrogen recovery zone. Light hydrocarbons include hydrocarbons having 4 carbon atoms or fewer.

The processes have several advantages. By separating the hydrogen-containing gas stream into the hydrogen-rich and hydrogen-lean streams before reforming, the methane reforming zone could be smaller, reducing capital and operating costs, and the reforming equilibrium conversion of light hydrocarbons can be higher, resulting in greater hydrogen yields and improved thermal efficiency. In addition, a higher hydrogen recovery rate can be obtained because a hydrogen-rich stream with higher purity is sent to the hydrogen recovery zone. The hydrogen-containing gas stream comprises 20 mol % or more of hydrogen, or

30 mol % or more, or 40 mol % or more, or 50 mol % or more, or 60 mol % or more, or 70 mol % or more, or 80 mol % or more. Any suitable hydrogen-containing stream may be used, including but not limited to, a coke oven gas (COG) stream, steam cracker off gas (formed in the cryogenic separation section of the process), off gas from a delayed coker, syngas from low temperature gasification processes (e.g., 800° C. or less, or 700° C. or less, or 600° C. or less), or combinations thereof

The hydrogen membrane separation unit includes a gas permeable membrane. The hydrogen-containing gas stream is contacted with the upstream surface of the membrane at an elevated pressure and a hydrogen-rich permeate stream is withdrawn from a downstream surface of the membrane at a reduced pressure relative to the feed pressure. A hydrogen-lean residue stream is withdrawn from the upstream surface of the membrane, typically at a pressure close to the feed pressure and intermediate between the feed pressure and the permeate stream pressure. “Hydrogen-rich permeate stream” means the permeate stream comprises about 70 mol % or more, or about 80 mol % to about 95 mol % hydrogen. “Hydrogen-lean residue stream” means the residue stream comprises about 50 mol % or less hydrogen, or about 10 mol % to about 40 mol %.

A variety of types of suitable designs of membrane separation systems may be used, including spiral-wound membranes, tubular membranes, and hollow fiber membranes, or the like. Typical membrane materials include metallic and inorganic membranes as well as various organic polymeric materials or such organic polymeric materials mixed with inorganic materials such as fillers, reinforcements and the like. Organic polymers include polysulfones; polystyrenes; including such styrene-containing polymers as acrylonitrile, styrene copolymers, styrene-butadiene and styrene-vinylbenzyl halide copolymers; cellulosic polymers, such as cellulose acetate, cellulose acetate-butyrate, methyl or ethyl cellulose; polyamides and polyimides; polycarbonates; polyurethanes, polyesters, including polyacrylates, polyethylene; polypropylene; polyvinyl pyridines, and the like. Such polymers may be either substituted or unsubstituted, with typical substituents of such substituted polymers including halogens, such as chlorine, fluorine and bromine; hydroxyl groups; lower alkyl groups; lower alkoxy groups; monocyclic aryl; lower acyl groups, etc.

The permeable membrane may include a coating material. Typical coatings include substituted or unsubstituted polymers that are either solid or liquid under gas separation conditions. Examples of such coating materials include synthetic and natural rubbers, organic prepolymers, polyurethanes, polyamines, polyesters and the like. The coatings may be polymerized either before or after application to the permeable membrane. The above descriptions of membrane designs, types of materials and coatings are provided for illustrative purposes and form no significant part of the present invention.

The reforming zone can include one or more reforming reactors for converting the methane and other light hydrocarbons to hydrogen and carbon monoxide. Suitable reforming reactors, include, but are not limited to, steam methane reformers (SMR), autothermal reformers (ATR), and partial oxidation reformers (POX).

The reforming zone can also include one or more water-gas shift reactors for converting carbon monoxide with steam to additional hydrogen and carbon dioxide. The effluent from the reforming zone comprises about 60 mol % to about 80 mol % hydrogen, about 0.2 mol % to about 5 mol % carbon monoxide, about 15 mol % to about 25 mol % carbon dioxide, and water (saturated).

The hydrogen recovery zone can include a H₂ PSA unit for separating the reforming zone effluent into a hydrogen rich product stream comprising the hydrogen and optionally a carbon dioxide rich product stream. The hydrogen recovery zone can also include a CO₂ recovery zone comprising one or more of a CO₂ PSA unit, an amine unit, and a cryogenic CO₂ fractionation unit for separating the reforming zone effluent in the CO₂ recovery zone into a CO₂-rich product stream and a CO₂-lean stream. The CO₂-lean stream is the feed stream to the H₂ PSA where it is separated to form a hydrogen-rich product stream and a hydrogen-lean tail gas stream “CO₂-rich” means the product stream comprises 90 mol % or more CO₂, or 95 mol % or more, or 97 mol % or more, or 98 mol % or more, or 99 mol % or more. “CO₂-lean” means the product stream comprises 5 mol % or less CO₂, or 2 mol % or less, or 1 mol % or less, or 0.5 mol % or less, or 0.1 mol % or less, or 0.05 mol % or less. “Hydrogen-rich product stream” means the product stream comprises 95 mol % or more hydrogen, or 96 mol % or more, or 97 mol % or more, or 98 mol % or more, or 99 mol % or more, or 99.9 mol % or more. “Hydrogen-lean tail gas stream” means the tail gas stream comprises 40 mol % or less hydrogen, or 30 mol % or less, or 20 mol % or less.

The hydrogen-containing gas stream can optionally be pretreated using one or more pretreatment processes. The pretreatment processes include, but are not limited to: removing tar, oil mist or both; removing H₂S, NH₃, HCN, or combinations thereof; removing naphthalene, benzene, or combinations; hydrotreating the hydrogen-containing gas stream to convert organic sulfur components to H₂S, or to saturate light olefins, or to remove Oz, or combinations thereof; removing H₂S from the stream. Light olefins include olefins with 4 carbon atoms or fewer. The various pretreatment processes can be performed in any suitable order.

The pretreatment processes can be carried out using any suitable processes. For example, tar, and/or oil mist can be removed in a guard bed, such as a carbon guard bed. Tar, and/or oil mist can also be removed in a electrostatic capturing device. H₂S, NH₃, and/or HCN can be removed in a guard bed, such as a FeO guard bed or a Fe—Cu guard bed, for example. H₂S, NH₃, and/or HCN can also be removed in a solvent absorber using monoethanolamine (MEA) or carbonate or ammonia as absorbing solvent, for example. Naphthalene and/or benzene can be removed in a temperature swing adsorption (TSA) unit or a hyper-gravity packed bed or a cooling device, for example. The organic sulfur components can be converted to H₂S, and/or the light olefins can be saturated, and/or O₂ can be removed in a hydrotreater, for example. H₂S can be removed in a guard bed, such as a ZnO guard bed, for example.

When a TSA unit is present, the adsorbents in the TSA unit can be regenerated using a portion of the purified gas from the TSA unit. The regenerated gas stream can be sent to the reforming zone as fuel gas, recycled to the TSA unit, or both.

For ease of discussion, the hydrogen-containing gas stream will be illustrated by a COG stream. Those skilled in the art will recognize that other hydrogen-containing gas streams could also be used.

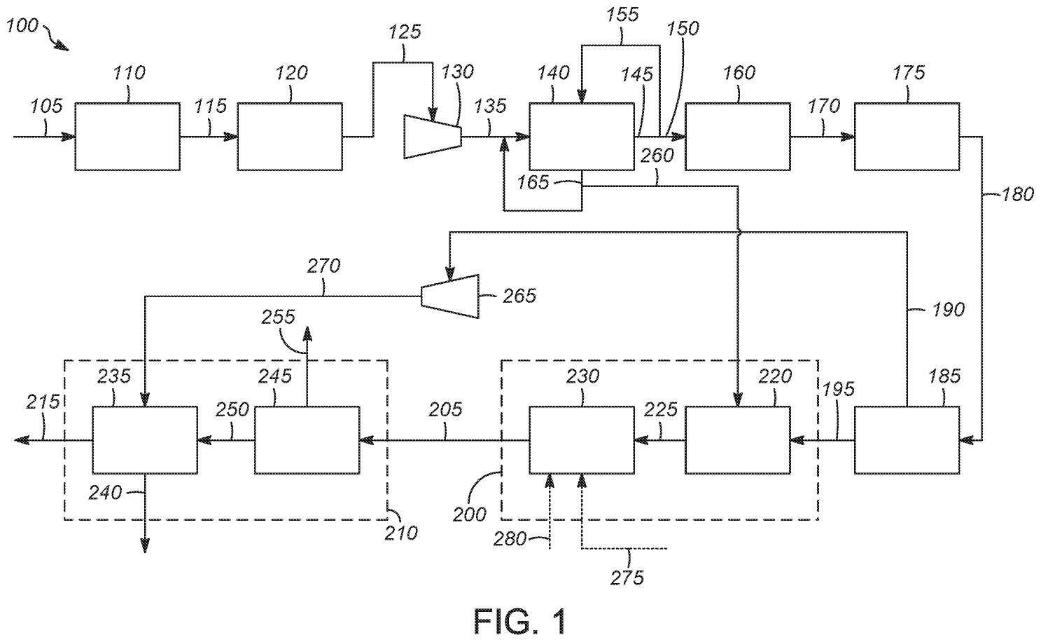

FIG. 1 illustrates one embodiment of a process 100 for making the maximum hydrogen from COG. The COG feed stream is sent to a carbon bed 110 where tar and oil mist is removed. The level of tar and oil mist is desirably less than or equal to 10 mg/Nm³.

The effluent 115 from carbon bed 110 is sent to a FeO guard bed 120 where H₂S, NH₃, and HCN are removed. The level of H₂S, NH₃ and HCN is desirably less than or equal to 1 mg/Nm³

The effluent 125 from the FeO guard bed 120 is compressed in compressor 130, and the compressed stream 135 is sent to a high-pressure TSA unit 140 to remove naphthalene, benzene, and the trace amount of tar and oil mist. The level of naphthalene and benzene is desirably less than or equal to 1 mg/Nm³.

The effluent 145 from the TSA unit 140 is split into two portions 150, 155. Portion 150 is sent to a hydrotreater 160 to convert organic sulfur components like COS, CS₂, RCH₂SH (R represents alkyl group), and CaHAS to H₂S, to saturate light olefins, and to remove Oz. The hydrotreater is loaded with different catalyst beds. The hydrotreater can comprise one or more vessels. There can be multiple beds in a single vessel, or one or more beds in two or more vessels.

Portion 155 is pressurized, heated, and recycled to the TSA unit 140. Portion 155 is used as the gas to regenerate the TSA adsorbents. All or a portion of the regeneration gas stream 165 can be recycled to the TSA unit 140.

The hydrotreated COG stream 170 is sent to a ZnO guard bed 175 to remove H₂S to a level desirably less than or equal to 0.1 ppm.

The effluent 180 from the ZnO guard bed 175 is sent to an H₂ membrane separation unit 185 where it is separated into a permeate stream 190 and a residue stream 195. The permeate stream 190 is a hydrogen-rich stream comprising about 70 mol % to about 95 mol % hydrogen and about 5 mol % to about 20 mol % methane, and the residue stream 195 is a hydrogen-lean residue stream comprising about 20 mol % to about 90 mol % methane, about 10 mol % to about 40 mol % hydrogen and about 2 mol % to about 20 mol % carbon monoxide.

The residue stream 195 is sent to the reforming zone 200.

The reforming zone effluent 205 from the reforming zone 200 is sent to a hydrogen recovery zone 210 where the hydrogen is separated out and recovered as hydrogen product stream 215.

The reforming zone 200 may include one or more reforming reactors 220. The methane in the residue stream 195 is converted into carbon monoxide and hydrogen in a reforming reactor, such as a steam reforming reactor, an autothermal reformer, or a partial oxidation reformer. The effluent 225 from the reforming reactor 220 comprising about 30 mol % to about 60 mol % hydrogen, about 1 mol % to about 10 mol % methane, about 1 mol % to about 20 mol % carbon monoxide and about 2 mol % to about 15 mol % carbon dioxide may be sent directly to the hydrogen recovery zone 210 as reforming zone effluent 205.

Alternatively, the reforming zone 200 may include one or more water-gas shift reactors 230. In this case, the effluent 225 from the reforming reactor 220 is sent to the water-gas shift reactor 230 where the carbon monoxide and water are converted to carbon dioxide and hydrogen. The effluent from the water-gas shift reactor 230 comprising about 60 mol % to about 80 mol % hydrogen, about 0.2 mol % to about 5 mol % carbon monoxide, about 15 mol % to about 25 mol % carbon dioxide, and water (saturated) would be sent to the hydrogen recovery zone 210 as reforming zone effluent 205.

The reforming zone effluent 205 contains hydrogen from the reforming reactor 220 and from the water-gas shift reactor 230 (if present). It may also contain carbon monoxide from the reforming reactor 220 and carbon dioxide from the water-gas shift reactor 230 (if present).

The hydrogen recovery zone 210 may include a H₂ PSA unit 235. The high-pressure H₂ PSA unit 235 separates the reforming zone effluent 205 into a high-pressure hydrogen product stream 215 and a tail gas stream 240. The tail gas stream 240 comprises carbon dioxide and carbon monoxide.

The hydrogen recovery zone 210 may include a CO₂ recovery zone 245. The CO₂ recovery zone 245 may include any suitable CO₂ separation equipment, including, but not limited to, a CO₂ PSA, an amine unit, and a cryogenic CO₂ fractionation unit. The reforming zone effluent 205 can be sent to the CO₂ recovery zone 245 where the reforming zone effluent 205 is separated into a CO₂ rich product stream 255 and a CO₂ lean stream 250. The CO₂ lean stream 250 is the feed stream to the H₂ PSA unit 235.

In some embodiments, a blast furnace gas stream 275, for example from a blast furnace in a steel plant, could also be routed to the water-gas shift reactor 230. A typical blast furnace gas comprises about 20 mol % to about 30 mol % carbon monoxide, about 30 mol % to about 50 mol % nitrogen, about 20 mol % to about 30 mol % carbon dioxide, about 3 mol % to about 10 mol % hydrogen, about 0.2 mol % to about 1 mol % argon, and about 3 mol % to about 8 mol % water. The carbon monoxide and water in the blast furnace gas stream 275 along with added steam stream 280 are converted to carbon dioxide and hydrogen. The blast furnace gas stream 275 is typically at low pressure from the blast furnace (e.g., about 0.1 to about 0.5 barg), and it is compressed before entering the WGS reactor 230. The nitrogen is separated out in the hydrogen recovery zone 210.

A portion 260 of the regeneration gas stream 165 can be sent to the reforming reactor 220.

The permeate stream 190 from the H₂ membrane separation unit 185 may be compressed in compressor 265 and the compressed permeate stream 270 can be sent to the hydrogen recovery zone 210.

### EXAMPLES

Table 1 shows a typical composition of the COG; the temperature, pressure and molar flow rate of the COG used in the examples are 40° C., 4 bara and 18000 Nm³/h. Simulations were run using UniSim Operations software (available from Honeywell) to show the effect of different process configurations.

TABLE 1
COG Composition

| | | |
|---|---|---|
| Composition, | H₂ | 58.80 |
| mol-% | O₂ | 0.40 |
| | N₂ | 3.80 |
| | CO | 5.90 |
| | CO₂ | 2.10 |
| | CH₄ | 25.60 |
| | C₂H₆ | 0.90 |
| | C₂H₄ | 2.30 |
| | C₃H₆ | 0.20 |
| | H₂S mg/Nm³ | ≤200 |
| | organic sulfide mg/Nm³ | ≤200 |
| | naphthalene mg/Nm³ | ≤200 |
| | tar mg/Nm³ | ≤50 |
| | C₆H₆ mg/Nm³ | ≤2000 |
| | oil mist mg/Nm³ | ≤200~300 |
| | HCN mg/Nm³ | ≤150 |
| | NH₃ mg/Nm³ | ≤100 |
| | Total | 100 |

### Example 1

The COG is sent to a non-regenerative activated carbon guard bed to remove the oil mist and tar to a level of less than 10 mg/Nm³.

The COG is then sent to a FeO guard bed to remove the H₂S, NH₃ and HCN to a level of less than 1 mg/Nm³.

The COG is compressed to 28 barg and sent to a TSA unit to remove the naphthalene and benzene to a level of less than 1 mg/Nm³. A portion of the TSA product stream is compressed and heated, and then recycled to the TSA unit to regenerate the TSA adsorbent. The regeneration gas is cooled by a cooler. One part of the regeneration gas is sent to the TSA unit as feed to improve the recovery rate, and the remaining regeneration gas is sent to the SMR furnace as fuel gas.

The TSA product stream is sent to the hydrotreating unit to convert organic sulfur components like COS, CS₂, RCH₂SH (where R represents alkyl group), and C₄HAS to H₂S, to saturate light olefins like ethylene, propylene, and to remove O₂.

The hydrotreating unit reaction effluent is sent to a ZnO guard bed to remove the H₂S to a level of less than 1 mg/Nm³.

The product gas from the ZnO guard bed is sent to a hollow-fiber membrane unit. The pressure of the hydrogen-rich permeate stream is 6 barg, and the hydrogen content is 90 mol %. The pressure of the hydrogen-lean residue stream is 26.8 barg, and the composition is methane, carbon dioxide and carbon monoxide are 23 mol % hydrogen, 49.5 mol % methane, 2 mol % carbon dioxide, and 11 mol % carbon monoxide.

The hydrogen-lean residue stream is sent to a steam reforming unit to convert the light hydrocarbons like methane, ethane, propane with steam to hydrogen and carbon monoxide. The pressure of the reforming effluent stream is 21.6 barg, and the content of hydrogen, methane, carbon dioxide and carbon monoxide are 45 mol %, 2.4 mol %, 7 mol % and 7.7 mol %, respectively.

The reforming effluent stream is sent to a water-gas shift unit to have carbon monoxide reacted with steam to generate more hydrogen and carbon dioxide. The pressure of the WGS effluent stream is 20 barg, and the content of hydrogen, carbon dioxide and carbon monoxide are 73 mol %, 18.6 mol % and 2 mol %, respectively.

The WGS effluent stream is sent to the H₂ PSA unit to recover the 99.99 mol % purity Hz product stream. The hydrogen-rich permeate stream coming from the hollow-fiber membrane unit is compressed to a pressure of 16 barg, and sent to the H₂ PSA unit to recover the 99.99 mol % purity H₂ product stream. The molar flow rate of the H₂ product stream is 23276 Nm³/h. The content of hydrogen and carbon dioxide in the H₂ PSA tail gas stream are 32 mol % and 43 mol %, respectively. The H₂ PSA tail gas is sent to the SMR furnace as fuel gas.

### Example 2

The difference between Example 1 and Example 2 is that the WGS effluent stream is sent to a CO₂ amine absorber first to get a 95 mol % purity CO₂-rich stream and a CO₂ lean stream. The CO₂-lean stream is combined with the compressed hydrogen-rich permeate coming from the H₂ membrane unit and fed to a H₂ PSA unit. The purity of the H₂ product stream is 99.99 mol %, and the molar flow rate is 24102 Nm³/h. The content of hydrogen and carbon monoxide in the H₂ PSA tail gas stream are 49 mol % and 11 mol %, respectively. The H₂ PSA tail gas is sent to the SMR furnace as fuel gas.

### Example 3

The difference between Example 1 and Example 3 is that a compressed blast furnace gas stream comprising 25.2 mol % carbon monoxide, 38.3 mol % nitrogen, 25.4 mol % carbon dioxide, 5.4 mol % hydrogen, 0.5 mol % argon, and 5.2 mol % water is sent to the WGS unit to convert the carbon monoxide to more hydrogen. Before compression, the temperature, pressure and molar flow rate of the blast furnace gas stream are 40° C., 0.2 barg and 2000 Nm³/h. The blast furnace gas is compressed to 22 barg. The pressure of the WGS effluent stream is 20 barg, and the content of hydrogen, carbon dioxide and carbon monoxide are 69 mol %, 20.3 mol % and 2.5 mol %, respectively.

The hydrogen-rich permeate stream coming from the hollow-fiber membrane unit is compressed to a pressure of 16 barg, the compressed hydrogen-rich permeate stream is combined with the WGS effluent stream, and the combined stream is sent to the H₂ PSA unit to recover the 99.99 mol % purity H₂ product stream. The molar flow rate of the H₂ product stream is 23715 Nm³/h. The content of hydrogen and carbon dioxide in the H₂ PSA tail gas stream are 28.3 mol % and 43.6 mol %, respectively. The H₂ PSA tail gas is sent to the SMR furnace as fuel gas.

### Example 4

The difference between Example 3 and Example 4 is that the WGS effluent stream is sent to a CO₂ amine absorber first to get the 95 mol % purity CO₂-rich stream and a CO₂-lean stream. The CO₂-lean stream is combined with the compressed hydrogen-rich permeate coming from the H₂ membrane unit and fed to a H₂ PSA unit. The purity of the H₂ product stream is 99.99 mol %, and the molar flow rate is 24539 Nm³/h. The content of hydrogen, nitrogen and carbon monoxide in the H₂ PSA tail gas stream are 40.7 mol %, 21.5 mol % and 11.5 mol %, respectively. The H₂ PSA tail gas is sent to the SMR furnace as fuel gas.

The term “about” means within 10% of the value specified, or within 5%, or within 1%.

### Specific Embodiments

While the following is described in conjunction with specific embodiments, it will be understood that this description is intended to illustrate and not limit the scope of the preceding description and the appended claims.

A first embodiment of the invention is a process for maximizing hydrogen production from a hydrogen-containing gas stream comprising separating a hydrogen-containing gas stream comprising hydrogen, methane, and carbon monoxide in a membrane separation unit into a hydrogen-rich permeate stream comprising the hydrogen and a hydrogen-lean residue stream comprising the methane and the carbon monoxide; reforming the hydrogen-lean residue stream in a reforming zone comprising a reformer to convert the methane to hydrogen and carbon monoxide and form a reforming zone effluent stream comprising hydrogen, carbon monoxide, and carbon dioxide; and recovering a hydrogen rich product stream from the reforming zone effluent in a hydrogen recovery zone, wherein the hydrogen-rich product stream comprises the hydrogen in the hydrogen-containing gas stream and the hydrogen made in the reforming zone. An embodiment of the invention is one, any or all of prior embodiments in this paragraph up through the first embodiment in this paragraph wherein the reforming zone further comprises a water-gas shift (WGS) reactor, and wherein reforming the hydrogen-lean residue stream comprises; reforming the hydrogen-lean residue stream in the reformer to form hydrogen, carbon monoxide, and carbon dioxide; and reacting the carbon monoxide in the reformer effluent stream with steam in the WGS reactor to form hydrogen and carbon dioxide forming a WGS effluent stream comprising hydrogen and carbon dioxide, wherein the hydrogen comprises the hydrogen in the hydrogen-containing gas stream, the hydrogen made in the reformer, and the hydrogen made in the WGS reactor; and wherein the WGS effluent stream comprises the reforming zone effluent stream. An embodiment of the invention is one, any or all of prior embodiments in this paragraph up through the first embodiment in this paragraph wherein the hydrogen recovery zone comprises a hydrogen PSA unit and wherein separating the reforming zone effluent comprises separating the reforming zone effluent in the hydrogen PSA unit into the hydrogen-rich product stream and a hydrogen-Jean tail gas stream. An embodiment of the invention is one, any or all of prior embodiments in this paragraph up through the first embodiment in this paragraph wherein the hydrogen recovery zone further comprises a CO₂ recovery zone comprising one or more of a CO₂ PSA unit, an amine unit, or a cryogenic CO₂ fractionation unit, and wherein separating the reforming zone effluent comprises separating the reforming zone effluent in the CO₂ recovery zone into a CO₂-rich product stream and a CO₂-lean stream; and introducing the CO₂-lean stream in the hydrogen PSA unit to form the hydrogen-rich product stream and the hydrogen-lean tail gas stream. An embodiment of the invention is one, any or all of prior embodiments in this paragraph up through the first embodiment in this paragraph further comprising compressing the hydrogen-rich permeate stream to form a compressed permeate stream; and introducing the compressed permeate stream into the hydrogen recovery zone. An embodiment of the invention is one, any or all of prior embodiments in this paragraph up through the first embodiment in this paragraph further comprising treating the hydrogen-containing gas stream before separating the hydrogen containing gas stream. An embodiment of the invention is one, any or all of prior embodiments in this paragraph up through the first embodiment in this paragraph wherein treating the hydrogen-containing gas stream comprises removing tar, oil mist, or combinations thereof from the hydrogen-containing gas stream; or removing H₂S, NH₃, HCN, or combinations thereof from the hydrogen-containing gas stream; or removing naphthalene, benzene, or combinations thereof from the hydrogen-containing gas stream; or hydrotreating the hydrogen-containing gas stream to convert organic sulfur components to H₂S, or to saturate light olefins, or to remove O₂, or combinations thereof; or removing H₂S from the hydrogen-containing gas stream, or combinations thereof. An embodiment of the invention is one, any or all of prior embodiments in this paragraph up through the first embodiment in this paragraph further comprising before separating the hydrogen-containing gas stream, removing naphthalene, benzene, or combinations thereof from the hydrogen-containing gas stream in a temperature swing adsorption (TSA) unit to form a purified hydrogen-containing gas stream. An embodiment of the invention is one, any or all of prior embodiments in this paragraph up through the first embodiment in this paragraph further comprising regenerating an adsorber in the TSA unit using a portion of the purified hydrogen-containing gas stream forming a regenerated gas stream. An embodiment of the invention is one, any or all of prior embodiments in this paragraph up through the first embodiment in this paragraph further comprising introducing all of the regenerated gas stream to the steam reformer as fuel gas; or recycling all of the regenerated gas stream to the TSA unit; or introducing a portion of the regenerated gas stream to the steam reformer as fuel gas, and recycling a portion of the regenerated gas stream to the TSA unit. An embodiment of the invention is one, any or all of prior embodiments in this paragraph up through the first embodiment in this paragraph wherein the reformer comprises a steam methane reformer, autothermal reformer, partial oxidation reformer, or combinations thereof. An embodiment of the invention is one, any or all of prior embodiments in this paragraph up through the first embodiment in this paragraph further comprising introducing a blast furnace gas stream comprising carbon monoxide from a blast furnace into the WGS reactor. An embodiment of the invention is one, any or all of prior embodiments in this paragraph up through the first embodiment in this paragraph wherein the hydrogen-containing gas stream comprises a coke oven gas stream, steam cracker off gas, off gas from a delayed coker, syngas from a low temperature gasification process, or combinations thereof.

A second embodiment of the invention is a process for maximizing hydrogen production from a hydrogen-containing gas stream comprising separating a hydrogen-containing gas stream comprising hydrogen, methane, and carbon monoxide in a membrane separation unit into a hydrogen-rich permeate stream comprising the hydrogen and a hydrogen-lean residue stream comprising the methane and the carbon monoxide; reforming the hydrogen-lean residue stream in a reformer to convert the methane to hydrogen and carbon monoxide and form a reformer effluent stream comprising hydrogen, carbon monoxide, and carbon dioxide; reacting the carbon monoxide in the reformer effluent stream with steam in a water-gas shift (WGS) reactor to form hydrogen and carbon dioxide, forming a WGS effluent stream comprising hydrogen and carbon dioxide, wherein the hydrogen comprises the hydrogen in the hydrogen containing gas stream, the hydrogen made in the reformer, and the hydrogen made in the WGS reactor; separating the WGS effluent stream in a CO₂ recovery zone into a CO₂-rich product stream and a CO₂-lean stream; and separating the CO₂ rich lean product stream in a H₂ PSA unit into a hydrogen-rich product stream and a hydrogen-lean tail gas stream. An embodiment of the invention is one, any or all of prior embodiments in this paragraph up through the second embodiment in this paragraph further comprising compressing the hydrogen-rich permeate stream to form a compressed permeate stream; and introducing the compressed permeate stream into the H₂ PSA unit. An embodiment of the invention is one, any or all of prior embodiments in this paragraph up through the second embodiment in this paragraph further comprising treating the hydrogen-containing gas stream before separating the hydrogen-containing gas stream. An embodiment of the invention is one, any or all of prior embodiments in this paragraph up through the second embodiment in this paragraph wherein treating the hydrogen-containing gas stream comprises removing tar, oil mist, or combinations thereof from the hydrogen-containing gas stream; or removing H₂S, NH₃, HCN, or combinations thereof from the hydrogen-containing gas stream; or removing naphthalene, benzene, or combinations thereof from the hydrogen containing gas stream; or hydrotreating the hydrogen-containing gas stream to convert organic sulfur components to H₂S, or to saturate light olefins, or to remove O₂, or combinations thereof; or removing H₂S from the hydrogen-containing gas stream; or combinations thereof. An embodiment of the invention is one, any or all of prior embodiments in this paragraph up through the second embodiment in this paragraph further comprising before separating the hydrogen containing gas stream, removing naphthalene, benzene, or combinations thereof from the hydrogen-containing gas stream in a temperature swing adsorption (TSA) unit to form a purified hydrogen-containing gas stream; regenerating an adsorber in the TSA unit using a portion of the purified hydrogen-containing gas stream forming a regenerated gas stream; and introducing all of the regenerated gas stream to the reformer as fuel gas; or recycling all of the regenerated gas stream to the TSA unit; or introducing a portion of the regenerated gas stream to the reformer as fuel gas, and recycling a portion of the regenerated gas stream to the TSA unit. An embodiment of the invention is one, any or all of prior embodiments in this paragraph up through the second embodiment in this paragraph further comprising introducing a blast furnace gas stream comprising carbon monoxide from a blast furnace into the WGS reactor. An embodiment of the invention is one, any or all of prior embodiments in this paragraph up through the second embodiment in this paragraph wherein the hydrogen-containing gas stream comprises a coke oven gas stream, steam cracker off gas, off gas from a delayed coke coker, syngas from a low temperature gasification process, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for maximizing hydrogen production from a hydrogen containing gas stream comprising:
separating a hydrogen-containing gas stream comprising hydrogen, methane, and carbon monoxide in a membrane separation unit into a hydrogen-rich permeate stream comprising the hydrogen and a hydrogen-lean residue stream comprising the methane and the carbon monoxide;
reforming the hydrogen-lean residue stream in a reforming zone comprising a reformer to convert the methane to hydrogen and carbon monoxide and form a reforming zone effluent stream comprising hydrogen, carbon monoxide, and carbon dioxide; and
recovering a hydrogen rich product stream from the reforming zone effluent in a hydrogen recovery zone, wherein the hydrogen-rich product stream comprises the hydrogen in the hydrogen-containing gas stream and the hydrogen made in the reforming zone.

2. The process of claim 1 wherein the reforming zone further comprises a water-gas shift (WGS) reactor, and wherein reforming the hydrogen-lean residue stream comprises;
reforming the hydrogen-lean residue stream in the reformer to form hydrogen, carbon monoxide, and carbon dioxide; and
reacting the carbon monoxide in the reformer effluent stream with steam in the WGS reactor to form hydrogen and carbon dioxide forming a WGS effluent stream comprising hydrogen and carbon dioxide, wherein the hydrogen comprises the hydrogen in the hydrogen-containing gas stream, the hydrogen made in the reformer, and the hydrogen made in the WGS reactor;
wherein the WGS effluent stream comprises the reforming zone effluent stream.

3. The process of claim 1 wherein the hydrogen recovery zone comprises a hydrogen PSA unit and wherein separating the reforming zone effluent comprises:
separating the reforming zone effluent in the hydrogen PSA unit into the hydrogen-rich product stream and a hydrogen-lean tail gas stream.

4. The process of claim 3 wherein the hydrogen recovery zone further comprises a CO₂ recovery zone comprising one or more of a CO₂ PSA unit, an amine unit, or a cryogenic CO₂ fractionation unit, and wherein separating the reforming zone effluent comprises:
separating the reforming zone effluent in the CO₂ recovery zone into a CO₂-rich product stream and a CO₂-lean stream; and
introducing the CO₂-lean stream in the hydrogen PSA unit to form the hydrogen rich product stream and the hydrogen-lean tail gas stream.

5. The process of claim 1 further comprising:
compressing the hydrogen-rich permeate stream to form a compressed permeate stream; and
introducing the compressed permeate stream into the hydrogen recovery zone.

6. The process of claim 1 further comprising:
treating the hydrogen-containing gas stream before separating the hydrogen containing gas stream.

7. The process of claim 6 wherein treating the hydrogen-containing gas stream comprises:
removing tar, oil mist, or combinations thereof from the hydrogen-containing gas stream; or
removing H₂S, NH₃, HCN, or combinations thereof from the hydrogen-containing gas stream; or
removing naphthalene, benzene, or combinations thereof from the hydrogen containing gas stream; or
hydrotreating the hydrogen-containing gas stream to convert organic sulfur components to H₂S, or to saturate light olefins, or to remove O₂, or combinations thereof; or
removing H₂S from the hydrogen-containing gas stream; or
combinations thereof.

8. The process of claim 1 further comprising:
before separating the hydrogen-containing gas stream, removing naphthalene, benzene, or combinations thereof from the hydrogen-containing gas stream in a temperature swing adsorption (TSA) unit to form a purified hydrogen-containing gas stream.

9. The process of claim 8 further comprising:
regenerating an adsorber in the TSA unit using a portion of the purified hydrogen containing gas stream forming a regenerated gas stream.

10. The process of claim 2 further comprising:
introducing a blast furnace gas stream comprising carbon monoxide from a blast furnace into the WGS reactor.

11. The process of claim 9 further comprising:
introducing all of the regenerated gas stream to the steam reformer as fuel gas; or
recycling all of the regenerated gas stream to the TSA unit; or
introducing a portion of the regenerated gas stream to the steam reformer as fuel gas, and recycling a portion of the regenerated gas stream to the TSA unit.

12. The process of claim 1 wherein the reformer comprises a steam methane reformer, autothermal reformer, partial oxidation reformer, or combinations thereof.

13. The process of claim 1 wherein the hydrogen-containing gas stream comprises a coke oven gas stream, steam cracker off gas, off gas from a delayed coker, syngas from a low temperature gasification process, or combinations thereof.

14. A process for maximizing hydrogen production from a hydrogen containing gas stream comprising:
separating a hydrogen-containing gas stream comprising hydrogen, methane, and carbon monoxide in a membrane separation unit into a hydrogen-rich permeate stream comprising the hydrogen and a hydrogen-lean residue stream comprising the methane and the carbon monoxide;
reforming the hydrogen-lean residue stream in a reformer to convert the methane to hydrogen and carbon monoxide and form a reformer effluent stream comprising hydrogen, carbon monoxide, and carbon dioxide;
reacting the carbon monoxide in the reformer effluent stream with steam in a water-gas shift (WGS) reactor to form hydrogen and carbon dioxide, forming a WGS effluent stream comprising hydrogen and carbon dioxide, wherein the hydrogen comprises the hydrogen in the hydrogen-containing gas stream, the hydrogen made in the reformer, and the hydrogen made in the WGS reactor;
separating the WGS effluent stream in a CO₂ recovery zone into a CO₂-rich product stream and a CO₂-lean stream; and
separating the CO₂-lean product stream in a H₂ PSA unit into a hydrogen-rich product stream and a hydrogen-lean tail gas stream.

15. The process of claim 14 further comprising:
compressing the hydrogen-rich permeate stream to form a compressed permeate stream; and
introducing the compressed permeate stream into the H₂ PSA unit.

16. The process of claim 14 further comprising:
treating the hydrogen-containing gas stream before separating the hydrogen containing gas stream.

17. The process of claim 16 wherein treating the hydrogen-containing gas stream comprises:
removing tar, oil mist, or combinations thereof from the hydrogen-containing gas stream; or
removing H₂S, NH₃, HCN, or combinations thereof from the hydrogen-containing gas stream; or
removing naphthalene, benzene, or combinations thereof from the hydrogen containing gas stream; or
hydrotreating the hydrogen-containing gas stream to convert organic sulfur components to H₂S, or to saturate light olefins, or to remove O₂, or combinations thereof;
or
removing H₂S from the hydrogen-containing gas stream; or
combinations thereof.

18. The process of claim 14 further comprising:
before separating the hydrogen-containing gas stream, removing naphthalene, benzene, or combinations thereof from the stream in a temperature swing adsorption (TSA) unit to form a purified hydrogen-containing gas stream;
regenerating an adsorber in the TSA unit using a portion of the purified hydrogen containing gas stream forming a regenerated gas stream; and
introducing all of the regenerated gas stream to the reformer as fuel gas; or
recycling all of the regenerated gas stream to the TSA unit; or
introducing a portion of the regenerated gas stream to the reformer as fuel gas, and recycling a portion of the regenerated gas stream to the TSA unit.

19. The process of claim 14 further comprising:
introducing a blast furnace gas stream comprising carbon monoxide from a blast furnace into the WGS reactor.

20. The process of claim 14 wherein the hydrogen-containing gas stream comprises a coke oven gas stream, steam cracker off gas, off gas from a delayed coker, syngas from a low temperature gasification process, or combinations thereof.
